(19) United States
(12) Patent Application Publication
(10) Pub. No.: US 2025/0218757 A1
(43) Pub. Date: Jul. 3, 2025

(54) ION GUIDE COMPRISING DC ELECTRODES

(71) Applicant: Thermo Fisher Scientific (Bremen) GmbH, Bremen (DE)

(72) Inventor: Hamish Stewart, Bremen (DE)

(73) Assignee: Thermo Fisher Scientific (Bremen) GmbH, Bremen (DE)

(21) Appl. No.: 19/005,700

(22) Filed: Dec. 30, 2024

(30) Foreign Application Priority Data
Jan. 3, 2024 (GB) 2400068.9
Apr. 18, 2024 (GB) 2405443.9

(51) Int. Cl. H01J 49/06

(52) U.S. Cl. CPC H01J 49/062

(57) ABSTRACT

An ion guide comprises an entrance for admission of ions into the ion guide, wherein the admitted ions are directed along a first axis. The ion guide also comprises a confinement device comprising an array of radio frequency (RF) electrodes formed along a first surface and configured to provide an RF field for confinement of the admitted ions. The ion guide also comprises a first direct current (DC) electrode configured to receive a DC potential and thereby provide a force on the admitted ions having a component in a second axis that is perpendicular to the first axis. The first DC electrode has a surface that is oblique to the first and second axes.

### CROSS-REFERENCE TO RELATED APPLICATIONS

This application claims priority from GB application number 2400068.9, filed 3 Jan. 2024 and GB Application 2405443.9, filed 18 Apr. 2024, both of which are incorporated herein by reference.

### FIELD OF THE INVENTION

The present disclosure relates to an ion guide. In particular the present disclosure provides ion guides which enable complex ion motion by using DC electrodes to alter the path of ions through the ion guide.

### BACKGROUND

Ion guides are traditionally linear devices which transport ions down a defined channel from an entrance to an exit. Ion guides are also able to trap ions for a duration of time. The most common ion guides are multipole ion guides, however channels may also be defined by an RF surface generated from a stacked series of ring electrodes with alternating RF applied to them.

For more complex ion manipulation, such as switching ion motion between several possible pathways, or generating the extended, folded pathways suitable for high resolution ion mobility analysis, more complex designs are required.

A two-dimensional plane may be formed by a stack of elongated electrodes that generates a flat RF surface that repels ions. Two such RF surfaces, or a single surface with a repulsive counter electrode, may form an RF carpet (G. Bollen, Int. J. Mass. Spectrom., 2011, 299, 131-138). U.S. Pat. Nos. 6,894,286B2 and 6,794,641B2 are related to trapped ions being manipulated within such a structure by DC gradients, DC barriers and travelling waves. Further examples of such a concept are Structure for Lossless Ion Manipulation (SLIM) ion guides U.S. Pat. Nos. 8,835,839B1, 9,812,311B2, 11,209,393B2. In such examples RF pseudopotential surfaces are generated on PCB printed electrodes, whilst supporting DC and T-Wave electrodes printed around the RF electrodes handle the transport of ions.

There are examples of known beam switching devices, e.g. devices which have a switchable ion path. SLIM devices are described in US20190103261A1, where such devices may be used as beam switching devices, whereby a potential is generated to inhibit motion of ions along a first direction. Other examples of beam switching devices are found in U.S. Pat. Nos. 7,829,850B2, 9,984,861B2, and 8,581,181B2.

In ion mobility analysis, where ions drift down a channel at differing velocities dependent on their mobility, higher resolution results from longer flight paths. Only SLIM ion guides and multi-pass cyclic ion guides have been demonstrated to generate flight paths greater than 10 meters.

Therefore, it is desirable to provide a simple ion guide that enables complex ion motion.

### SUMMARY

In accordance with a first aspect, there is provided an ion guide comprising:
an entrance for admission of ions into the ion guide, wherein the admitted ions are directed along a first axis;
a confinement device comprising an array of radio frequency (RF) electrodes formed along a first surface and configured to provide an RF field for confinement of the admitted ions; and
a first direct current (DC) electrode configured to receive a DC potential and thereby provide a force on the admitted ions having a component in a second axis that is perpendicular to the first axis, the first DC electrode having a surface that is oblique to the first and second axes.

It has been appreciated by the present inventor that an ion guide having a DC electrode configured to receive a DC potential has the advantage that the ions which are initially being directed along a first axis may then be forced along a second axis by the force provided by the DC electrode. It has been appreciated that by providing an ion guide which has a DC electrode with a surface oblique to the first and second axes, the ions are forced along the oblique surface, as the force produced has a component in the second axis. Therefore, the ion path may be changed by the DC electrode, which provides a more complex ion path without requiring a complex system. By providing an ion guide for a complex ion path, the ion guide can be used for folded ion paths, switchable or branched pathways, or to compress, expand, and/or split the ion beam. The ion guide therefore results in a complex ion path whilst being mechanically and electronically simple. It is relatively low-cost and simple to construct DC electrodes within an array of electrodes, as will be described herein.

The ions may be admitted into the ion guide along the first axis. Alternatively, the ions may be admitted into the ion guide in a direction different to the first axis. Therefore, the entrance may be at any location within the ion guide, and the same technical result will be achieved, i.e. the ions will be directed towards the oblique surface of the DC electrode.

The ions may be directed along the first axis by either a DC gradient or DC travelling wave being applied to the array of electrodes, or by a gas force. Alternatively or additionally, the ion guide may further comprise additional DC electrodes, e.g. which may be mounted between the RF electrodes of the first surface, and a DC gradient or DC travelling wave may be applied to the additional DC electrodes to direct the ions along the first axis. Alternatively or additionally, additional DC electrodes may be provided in a counter electrode, where a counter electrode will be described herein. This has the advantage that the ions are directed, i.e. forced, in a direction after admission into the ion guide, wherein the direction in which the ions are directed can be independent of the direction the ions are admitted in. The direction in which the ions are travelling in can be altered by the DC gradient, DC travelling wave or gas force, i.e. the ions are directed by a first force. The ions can therefore be forced in a direction towards the first DC electrode which may or may not be in the direction in which the ions were initially admitted into the ion guide.

The entrance may be configured such that the ions are admitted into the ion guide along a first axis. Alternatively, the entrance may be configured such that the ions are admitted into the ion guide in a direction different to the first axis, such as along the second axis.

The array of RF electrodes may form an RF surface.

The ion guide may further comprise an exit through which ions are extracted. The entrance and exit may be offset from one another in the second axis (i.e. z axis), wherein the second axis is perpendicular to the first axis (i.e. x axis). The entrance and exit may be in the same plane, wherein the plane is substantially parallel to the first surface. The ions may travel approximately in the plane in which the entrance (i.e. inlet) and exit (i.e. outlet) are located. Therefore, the ions can move from an entrance to an exit by being moved in approximately the same plane, rather than being required to change planes, i.e. to move closer to or further from the RF surface. After the ions are admitted into the entrance, the one or more DC electrodes may move the ions in the z direction (a direction along the z axis) while the ions are moving in an x direction (a direction along the x axis) between the side of the ion guide comprising the entrance and the side of the ion guide comprising the exit. In some embodiments, the ions may be separated from neutral contaminants by moving the ions in different directions within approximately the same plane. The ions are moved in the z direction as well as the x direction, such that the ions travel from the entrance to the exit. Whereas, neutral contaminants only travel in the x direction, due to their lack of charge, and therefore do not leave the ion guide via the exit, as the entrance is offset from the exit. The first DC electrode may be located on one side of the exit, and a second DC electrode may be provided on the other side of the exit, such that the exit is located within a gap between the first and second DC electrodes. The first and second DC electrodes may each have a surface, which is oblique to the first and second axis (herein referred to as an oblique surface), configured to urge ions in opposite z-directions towards the exit, so that the ion beam is compressed in the z direction when the ions are extracted through the exit (i.e. extracted from the ion guide via the exit). The entrance may have a greater width in the z direction than the exit. The ion guide may be arranged between an ion source configured to provide the ions to the inlet, and a vacuum chamber for receiving the ions from the outlet.

The first DC electrode may have a length along the second axis, a width along the first axis and a depth along a third axis (which is perpendicular to each of the first and second axes). The first DC electrode may be a substantially flat electrode that is arranged in a plane substantially parallel to the first surface. That is, the electrode's depth may be substantially constant and may be significantly smaller than its length. The electrode's width may be constant or may vary along its length.

The first direct current (DC) electrode is configured to receive a DC potential, e.g. from a voltage source. The resulting electric field should be repulsive to ions within the ion guide.

The first DC electrode may be wedge shaped, such that the first DC electrode may have a triangular cross section. The oblique surface may join a first end of the electrode to a second of the electrode. The electrode having this shape has the advantage that the electrode is easy to mount in the device, whilst still providing the required oblique surface. The simple shape of the electrode also enables the electrode to be constructed from low-cost material such as laser cut material or stamped or etched material.

The first DC electrode may be arranged in the same plane as the array of electrodes, i.e. along the first surface. This has the advantage that the DC electrode may be formed using the same substrate as the one or more electrodes in the array of electrodes.

A second RF surface or a counter-electrode may be located at a second surface of the confinement device. The second surface may be opposite the first surface, i.e. may face the first surface in a direction along a third axis. The third axis is defined herein as being perpendicular to each of the first and second axes. The second surface (together with the first surface) may be configured to confine the ions approximately to a plane between the first and second surfaces (i.e. as the ion travels travel though the confinement device). Ions will in general undergo oscillatory motion as they travel though the confinement device, with their average positions being approximately described by the plane between the first and second surfaces.

The first DC electrode may be located in between the first and second surfaces. For example, the first DC electrode may be located midway between the first and second surfaces. The first DC electrode may be arranged such that it is not in direct contact with either of the first surface and the second surface. This has the advantage that the DC electrode does not interfere with the function of the RF surfaces, as the DC electrode does not mechanically or electrically interact with the RF surfaces. The first DC electrode may be separated from each of the RF surfaces by one or more spacers, wherein the spacers may be insulating spacers. The first DC electrode may be mounted to the ion guide using a mounting part. The mounting part may be located at the edge of the ion guide.

The first DC electrode may be one of a plurality of DC electrodes, wherein each of the plurality of DC electrodes is arranged in the same plane, e.g. such that a layer of DC electrodes is formed. The use of multiple DC electrodes enables additional forces to be applied to the ions, such that the ion path can be more complex as the ions can be directed in multiple directions at different points along the RF surface.

The DC electrode may be located at the periphery of the first or second surface. This has the advantage that the DC electrode will not interfere with the function of the RF surface whether or not the DC electrode is located in the same plane as the RF surface.

The ion guide may comprise one or more DC guard electrodes, where the one or more DC guard electrodes may be located between the first and second surfaces (e.g. along a third axis) or in the same plane as the first or second surface. A DC guard electrode has the advantage that it can control the direction of deflection caused by the DC electrode (e.g. where the electrode is wedge shaped). The DC electrode may be referred to as a wedge electrode, or wedge-shaped DC electrode. Therefore, the DC electrode and DC guard electrode may be used to force the ions in a direction. The DC guard electrode and the wedge-shaped DC electrode have repulsive potentials applied to them. The voltage applied to the wedge-shaped DC electrode can be controlled to be different to, i.e. greater or less than, the voltage applied to the guard electrode. By applying a voltage to the DC electrode that is either greater than or less than the voltage applied to the DC guard electrode, the direction of the force along the second axis provided by the DC electrode can be controlled to be either in a first direction along the second axis or in the opposite direction (i.e. in a second direction) along the second axis. For example, the voltage applied to the wedge-shaped DC electrode may be greater than 20V, or less than 0V. In such an example, the voltage applied to the guard electrode may be 10V. The voltage applied to the guard electrode and wedge-shaped DC electrode may be any other suitable values. The one or more DC guard electrodes may be located in the same plane as the DC electrode, or may be located in a different plane to the DC electrode. If the one or more DC guard electrodes and DC electrode are located in the same plane, both the DC electrode and the one or more DC guard electrodes may be printed electrodes. However, in such a case, the DC electrode will require a higher voltage, than the case in which the DC electrode and one or more DC guard electrodes are on different planes.

The ion guide may comprise a second DC electrode, wherein the first DC electrode is located on a different side of the ion guide to the second DC electrode such that the first and second DC electrodes are located at different positions along the x axis. In other words, the first and second DC electrodes are located on different sides of the ion path. The ion path may be defined as the path that the ions would take based on the electrodes and the voltages applied thereto. In other words, the first and second DC electrodes are located on different sides of the entrance and exit, such that the entrance is located between the first and second DC electrodes, and the exit is also located between the first and second DC electrodes. The ion guide may comprise first and second DC guard electrodes which may also be located on different sides of the ion path, i.e. on different sides of the entrance and exit. The first DC guard electrode may be positioned between the first DC electrode and the first surface, or the first DC electrode may be positioned between the first DC guard electrode and the first surface.

The second DC guard electrode may be positioned between the second DC electrode and the first surface, or the second DC electrode may be positioned between the second DC guard electrode and the first surface.

Each of the DC electrodes may be substantially aligned with one of the DC guard electrodes, such that the first DC electrode and first DC guard electrode may be substantially aligned along the first and second axes (x axis and z axis), and the second DC electrode and second DC guard electrode may be substantially aligned along the first and second axes (x axis and z axis). The first DC electrode and first DC guard electrode may be separated along the third axis (the y axis). The second DC electrode and the second DC guard electrode may be separated along the third axis. Each of the DC electrodes may be electrically isolated from each of the DC guard electrodes.

The first DC electrode may be an upper DC electrode, wherein the ion guide further comprises a lower DC electrode, such that the lower DC electrode is located in between the upper DC electrode and the first surface (along a third axis). By having an upper and lower electrode, it is possible to control the ion direction by providing a different voltage to the upper and lower DC electrodes. The upper DC electrode and/or lower DC electrode may be wedge shaped. For the sake of terminology, the electrodes are referred to as lower electrodes and upper electrodes, however this does not limit the electrodes to having a difference in height. The upper and lower electrodes may be separated along the y axis.

The upper DC electrode may be one of a pair of upper DC electrodes, and the lower DC electrode may be one of a pair of lower DC electrodes, wherein the electrodes of the pair of upper DC electrodes are located at different sides of the ion path in use. In other words, one upper DC electrode of the pair of upper DC electrodes may be located on one side of the ion guide, and the other upper DC electrode of the pair of upper DC electrodes may be located on the other (i.e. opposing) side of the ion guide. The same is true for the lower DC electrodes. The lower DC electrodes may be positioned between the pair of upper DC electrodes and the first surface, wherein each electrode of the pair of upper DC electrodes is substantially located in the same location along the x axis as an electrode of the pair of lower DC electrodes. By having upper and lower electrodes on both sides of the ion guide, the ion direction (i.e. ion path) can be further controlled by providing different voltages to some or all of the DC electrodes. The upper and lower DC electrodes are configured such that the force provided on the admitted ions can be controlled to be either in a first direction along the first axis or in a second direction along the first axis. The upper DC electrodes may be electrically isolated from each of the lower DC electrodes. The upper pair of DC electrodes is located in a plane parallel to the plane in which the lower pair of DC electrodes are located, and the electrodes of the upper pair are located at opposite sides of the ion guide in the first axis, and each electrode of the lower pair is located at the same position in the first axis as the corresponding electrode of the upper pair, such that the first pair of electrodes and second pair of electrodes are substantially aligned in the x and z directions. For example, in embodiments in which the electrodes are different shapes, it will be appreciated that one of the upper electrodes may be substantially aligned with the corresponding lower electrode, however due to the different shapes of the electrodes the alignment may not be exact. For example, an electrode of the upper pair may overlap, or partially overlap the corresponding electrode of the lower pair.

The electrodes of the upper and lower DC electrode pairs may be wedge shaped. The use of two pairs of wedge-shaped DC electrodes enables the direction of the ions to be further controlled.

The wedge shaped DC electrodes may have different configurations, for example the first electrode of the lower DC electrode pair may have an oblique surface which becomes closer to (approaches) the ion path, in the x direction, whereas the oblique surface of the second electrode of the lower DC electrode pair becomes further away from the ion path, in the x direction. Additionally or alternatively, an electrode of the upper DC electrode pair may have a surface with an opposite configuration to the corresponding electrode of the lower DC electrode pair. By providing electrodes of opposite configurations, the ions can be directed in first or second direction in the z direction by applying a repulsive potential to one or more of the electrodes.

The ion guide may comprise one or more exits, and the entrance may be one of a plurality of entrances. The entrances and exits (i.e. the apertures) may be located on the ion guide such that they are each at different locations in the x-z plane. In other words, each of the apertures may be separated from each of the other apertures in the x and/or y direction. In some examples, the one or more exits and plurality of entrance (i.e. the apertures) may be located such that each of the exits and entrances are located adjacent to, or at, a corner of the ion guide. For example, the ion guide may comprise four apertures, wherein the apertures may be located at each corner of a rectangular ion guide. The ions entering one of the plurality of entrances may be ejected from any one of the exits by controlling the voltages applied to one or more of the DC electrodes.

The first DC electrode may be one of a plurality of DC electrodes, wherein each of the plurality of DC electrodes can be configured similarly to, or the same as, the first DC electrode. Each of the plurality of electrodes may be separated, along the x axis, from the other electrodes in the plurality of electrodes. The plurality of electrodes may be substantially parallel to each other, in other words the plurality of electrodes may be located in the same x-z plane. Each of the plurality of electrodes may have a surface which is oblique to the first and second axes. One or more of the plurality of electrodes may be arranged such that the ions are forced in a first direction along the first axis. One or more of the remaining plurality of electrodes may be arranged such that the ions are forced in a second direction along the first axis. In other words, the electrodes may be configured to force ions in different directions along the first axis. Therefore, the plurality of DC electrodes may define a path which is not a straight line between the entrance (inlet) and exit (outlet), where the ions are caused to follow the path. In other words, the path between the entrance and exit is not a direct path, and instead the path between entrance and exit may be curved. For example, the ion guide may define a winding, circuitous, folded, and/or zig-zag path. The path may be angled. For example, the path may comprise one or more angled portions, i.e. the path may comprise multiple segments wherein each segment is connected at an angle to the adjacent segments. Repulsive potentials may be applied to the DC electrodes, such that when the ions are urged along the first axis (e.g. in the x direction), the ions are caused to follow the curved path from the entrance to the exit. This can be advantageous, in particular, for ion mobility separators, where longer ion paths can provide increased ion mobility resolution.

The ion guide may be configured to cause the ions to follow an elongated ion path between the entrance and exit.

In another aspect, there may be provided a beam switching device which may comprise an ion guide described herein.

In another aspect, there may be provided an ion mobility separator which may comprise an ion guide described herein.

In another aspect, there may be provided an analytical instrument, such as a mass spectrometer, comprising any one or more of: an ion guide, a beam switching device, and/or an ion mobility separator as described herein.

### BRIEF DESCRIPTION OF DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labelled in every figure.

FIG. 1A shows an example of an electrode for use in an embodiment;

FIG. 1B shows an example of an electrode for use in an embodiment;

FIGS. 2A, 2B and 2C show a top-down view, side view and side view, respectively, of an ion guide according to an embodiment;

FIG. 3 shows a perspective view of an ion guide according to an embodiment;

FIG. 4 shows a perspective view of an ion guide according to an embodiment;

FIG. 5 shows a top-down view of an ion guide according to an embodiment;

FIG. 6A shows a perspective view of an ion guide according to an embodiment;

FIG. 6B shows a graph illustrating the path of ions within the ion guide of FIG. 6A;

FIG. 7 shows a graph illustrating the path of ions within an ion guide according to an embodiment; and

FIG. 8 shows a mass spectrometer incorporating an ion guide according to an embodiment.

### DETAILED DESCRIPTION OF EMBODIMENTS

The disclosure will now be described in relation to specific embodiments. The embodiments described herein are not intended to be limiting and are for illustrative purposes.

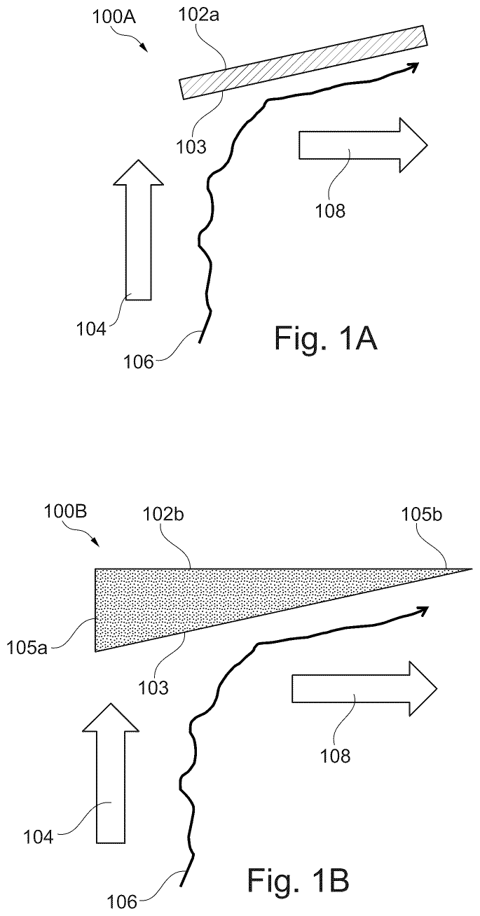

FIG. 1A shows a first example of an electrode configuration 100A configured for use within an ion guide according to the present disclosure. As shown in FIG. 1A, in this configuration the ion path 106, i.e. in the direction in which the ions travel, is initially in a direction along a first axis. The ions are directed in a first direction due to a first force 104 in a first axis, where it will be understood that ions being directed in a first direction may not result in the ions travelling in a first direction. Instead, the ions are forced in a first direction which results in the direction of the ions having a component in the first direction, where the direction of movement of the ions may also have a component in a second direction such that the ions move at an angle to both the first and second direction. As will be described herein, the first force 104 on the ions is in the first direction, i.e. along the first axis, which may be due to a DC gradient or DC travelling wave applied to an array of RF electrodes (as will be described herein), or due to a gas force (e.g. due to gas jets or additional gas flows).

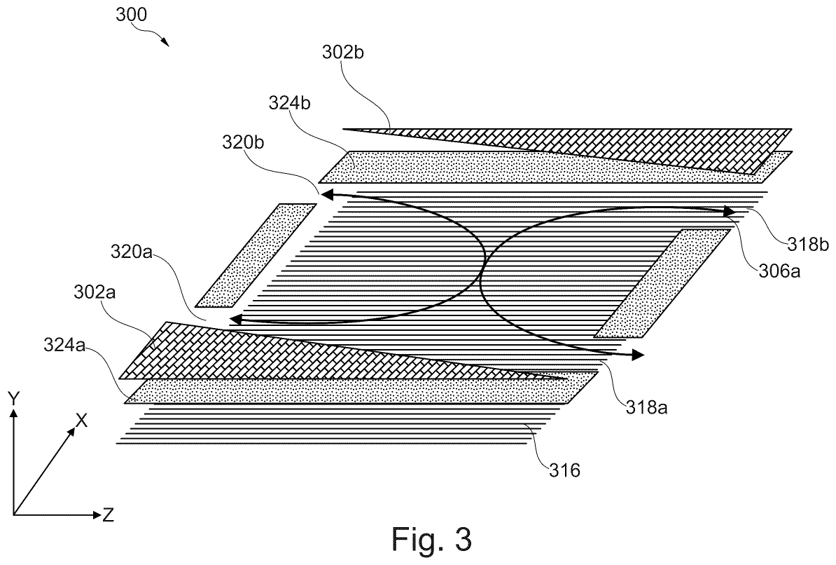

As shown in FIG. 1A, there is also a DC electrode 102a which comprises a surface 103 which is oblique to the first axis and the second axis, wherein the second axis is in a direction orthogonal to the first axis. Therefore, the ions travelling in a first axis are travelling at an angle to the surface of the electrode 102a. The ions are pushed by the first force and interact with the oblique surface 103 of the electrode 102a. A second force 108 is applied to the ions by the electrode and its oblique surface 103, wherein the second force has a component in the second axis, such that the ion path 106 is altered, and the ions move in a second direction. The second direction, i.e. the subsequent direction of travel of the ions, may be different to the direction of the second force 108. In the example shown in FIG. 1A, the initial path of the ion is in a first axis, and the subsequent path of the ion 106 is substantially parallel to the oblique surface of the electrode 103, such that the subsequent ion path is at an angle to both the first and second axes. Whereas the direction of the force 108 is in the second axis, which is orthogonal to the first axis. It will be appreciated, and described for example in relation to FIG. 3, that the initial path of the ions, and the subsequent path of the ions may be in different directions to those described in relation to FIG. 1A.

FIG. 1B shows a second example of an electrode configuration 100B for use within an ion guide according to the present disclosure. The initial and subsequent motion of the ions is the same as described in FIG. 1A. The first and second forces have the same direction as those described in relation to FIG. 1A. The difference between the configurations of FIGS. 1A and 1B, is the shape of the electrode 102b. In the example shown in FIG. 1B, the electrode has a wedge shape, such that it has a first end 105a and a second end 105b, wherein the first end has a first width, and the second end has a second width. The width of the first end is greater than the width of the second end. The first end 105a has a face which is directed along the second axis, and the second end 105b has a point which is directed along the second axis. Therefore, the electrode 102b has a triangular cross section such that the electrode 102b has a surface 103 which is oblique to the first axis and the second axis, wherein the second axis extends in a direction orthogonal to the first axis. Therefore, the oblique surface 103 joins the first end 105a and the second end 105b of the electrode 102b. The electrode is orientated such that the oblique surface 103 interacts with the ion path 106. A second force 108 is applied to the ions for the same reasons as described in relation to FIG. 1A. Therefore, although the electrode 102b of FIG. 1B has a different shape to the electrode 102a of the FIG. 1B, the effect on the ions is substantially the same, due to both electrodes being orientated such that they have an oblique surface which results in a force which interacts with the ions.

It will be appreciated that although the embodiments described herein are in relation to an electrode having a wedge shape, the electrode may be any shape which has a suitable oblique surface for applying the required force to the ions. In other words, the electrode may be any shape which has a surface which is oblique to the first and second axes. For example, the electrode may have a trapezium cross section, or may have a rectangular cross section. Therefore, although some examples refer to a wedge-shaped electrode, any suitable shaped electrode may be used in the examples described herein, to achieve the same technical effects. Therefore, such a non-wedge-shaped electrode may be combined with any of the examples described herein, instead of a wedge-shaped electrode.

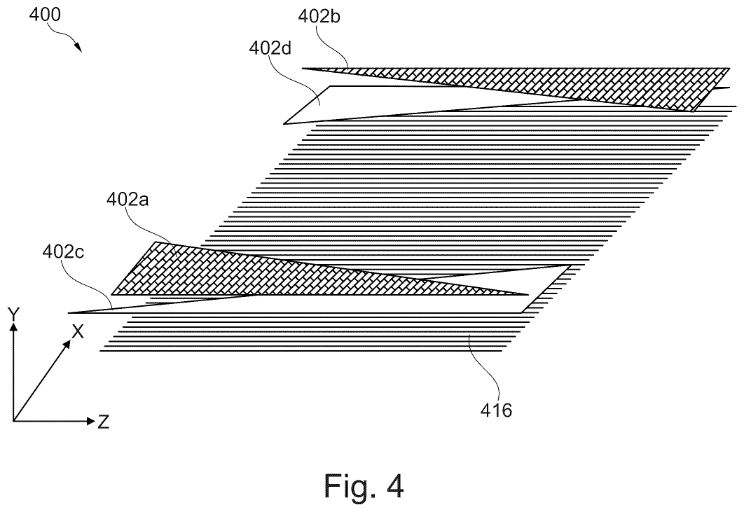

As referred to herein, and illustrated best in FIGS. 3 and 4, the ion guiding system of the embodiments is described in relation to a three-dimensional coordinate system, such that the ion guiding system has an x axis, y axis and z axis. As shown in FIGS. 3 and 4, the RF electrodes described herein have a length extending along the z axis. The RF electrodes also have a width extending along the x axis, where the x axis is perpendicular to the z axis. The y axis is perpendicular to both the x and z axis, and defines a height, or depth, of the device. These axes will be used herein to define features.

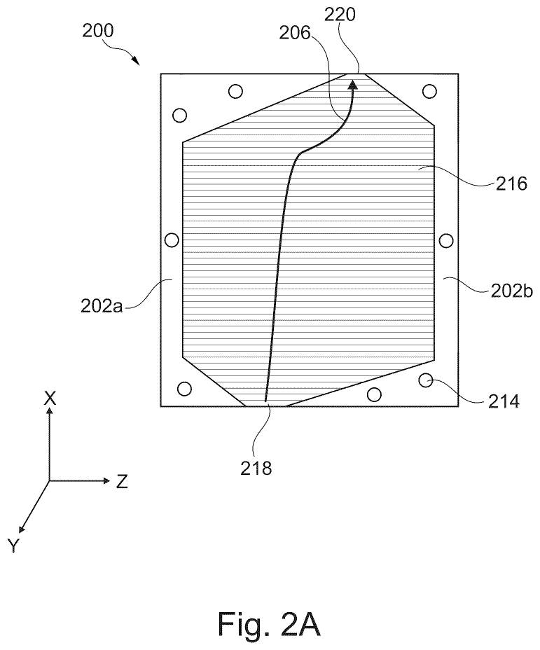

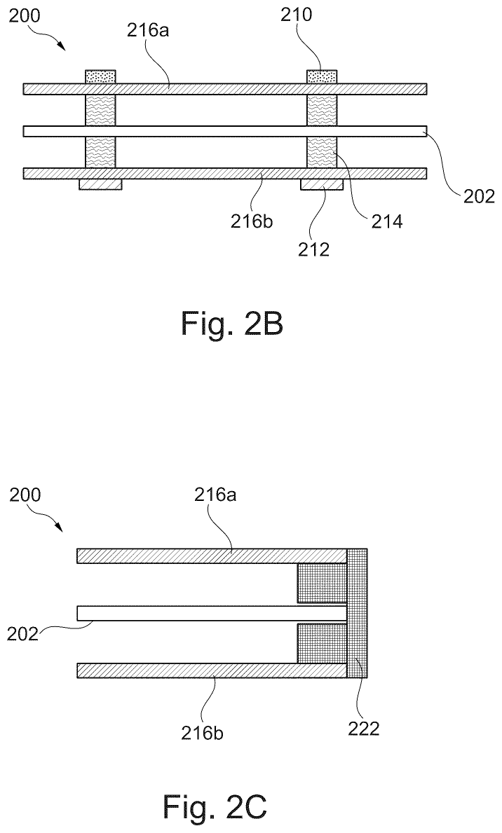

FIGS. 2A, 2B and 2C illustrate an ion guide 200 which comprises two RF surfaces 216a and 216b, and at least one DC electrode 202. As described herein, the RF surface comprises a plurality of RF electrodes extending in an x-z plane.

The RF surface described herein may also be referred to as an RF carpet, or RF ion carpet. The RF surface is formed from a plurality of electrodes having a substantially planar surface and configured to receive RF voltages such that there is a voltage phase difference between adjacent electrodes of the plurality of electrodes. In other words, one or more (or each) of the plurality of electrodes may have a substantially planar face. The RF surface may thus generate a substantially planar RF pseudopotential surface parallel to the RF surface when receiving the RF voltages. The plurality of electrodes may be considered to collectively have a substantially planar surface, even if not all of the plurality of electrodes each have a substantially planar face. The planar surface may extend along first and second axes (e.g. x and z axes), which may be perpendicular to one another.

The RF surface may be substantially planar but need not be completely flat. For example, the electrodes may include indentations or protrusions or be wedge-shaped to direct or compress an ion beam.

The ions travelling through ion guide according to one of the examples described herein, are confined by a confinement device disclosed herein. The confinement device confines the ions approximately to a plane, where the plane is substantially parallel to a first RF surface, i.e. the plane is substantially parallel to the x-z plane formed by the plurality of electrodes. In some embodiments the confinement device comprises a second surface, i.e. a top surface, wherein the second surface is located opposite to the RF surface. As such, the confinement field may be provided by a combination of the first and second RF surfaces. The first and second surface may also be referred to as the bottom and top plates. The first and second surface are located relative to each other such that the first and second surface substantially overlap. Ions may travel through the ion guiding system while being confined within the ion guiding system. Ions will in general undergo oscillatory motion as they travel though the ion guiding system, with their average positions being approximately described by a plane.

Although the embodiments herein will be described as having a second RF surface as the top surface, the second surface may alternatively be a DC repeller plate. As such, the second confinement field may be provided by a combination of the RF surface and the DC repeller plate. The same technical considerations apply with the use of a DC repeller plate, and therefore any embodiment described herein could instead be implemented with a DC repeller plate instead of a second RF surface. In ion guiding systems comprising a DC repeller plate (also referred to as a DC counter electrode) it is possible to taper the RF quadrupole electrodes into the DC surface.

A DC repeller plate is configured to apply a repelling voltage that repels the ions towards the RF surface. The DC repeller plate is therefore configured to confine the ion beam between the repeller plate and the RF surface. The repeller plate may be configured to prevent the ion beam from approaching the repeller plate, avoiding contamination and charging effects on the repeller plate. Therefore, by using a confinement device, the ions substantially reside, and travel, in a plane above the lower RF surface. In the embodiment in which the confinement device comprises a second surface, e.g. a DC repeller plate or a second RF surface, the ions reside, and travel, in a plane between the lower RF surface and the top surface.

In the embodiment shown in FIG. 2A, the one or more DC electrodes 202 are located between the two RF surfaces, such that the one or more DC electrodes are sandwiched between the RF surface surfaces. The one or more DC electrodes are located around the periphery of the RF surfaces such that there is a central portion of the RF surface which is not overlayed, in the y direction, by a DC electrode. In other words, the one or more DC electrodes cover a smaller area than the RF surface, such that there is a portion of the RF surface which is not covered by the one or more DC electrodes.

As shown in FIG. 2A the ion guide may comprise one or more DC electrodes. For example, in the ion guide 200, there are two DC electrodes 202a and 202b. The DC electrodes 202a and 202b are located opposite each other, such that they are both located in the same plane. The plane in which the DC electrodes are located is parallel to the plane in which the one or more RF electrodes are located, i.e. in a plane parallel to the RF surface 216. The DC electrodes are not in physical contact, such that a gap is formed at the front of the device, which provides an entrance 218, and a gap is formed at the back of the device which provides an exit 220 to the ion guide. The entrance and exit may be entrance and exit apertures; however the entrance and exit are not required to be apertures. The ions are admitted into the ion guide via the entrance 218, and the ions travel along the x axis such that the ions travel towards the opposing side of the ion guide, in which the exit 220 is located. The DC electrodes may be shaped such that the entrance and exit of the ion guide are not in line with each other, i.e. the exit may be positioned at a different position along the z axis than the entrance. Therefore, ions initially travelling in the x direction, from the entrance, will be required to move in the z direction in order to exit the ion guide. The DC electrodes 202a and 202b comprise one or more oblique surfaces, such that the ions interact with one or more surfaces of one or more of the DC electrodes. The DC electrodes in this embodiment have wedge shaped portions, however the DC electrodes also have surfaces which are parallel to the first axis. In other words, the DC electrodes have one or more surfaces which are oblique to the first and second axes, thus forming wedge shaped portions, and one or more surfaces which are parallel to the first or second axes. The DC electrodes shown in FIG. 2A comprise wedge shaped portions which are located on opposing sides of the RF surface, wherein the opposing sides are the same sides which comprise the entrance and exit apertures. The surfaces which are parallel to the first axis are located on opposing sides, where the sides are different to the sides on which the wedge-shaped portions are located.

The DC electrodes 202a and 202b provide a force on the ions which offset the path of the admitted ions, such that the ions can be ejected from the ion guide through an exit which is at a different position along the z axis compared to the entrance in which the ions are admitted into the ion guide. In other words, the exit is offset from the entrance along a z axis. The ion path is therefore not straight, i.e. the ions do not only travel in the x direction, and instead the ions travel in the z direction as well as the x direction. The ion path is substantially constant in the y axis, i.e. the ions travel in a plane substantially parallel to the plane in which the RF electrodes extend. The DC electrodes 202a and 202b may also be referred to as guard electrodes, wherein the one or more guard electrode plates incorporate wedge shaped electrodes, i.e. the guard electrode plates comprise one or more surfaces which are oblique to the first and second axes, as described herein. As described herein, the ion guide may comprise DC electrodes and DC guard electrodes, or alternatively the DC electrodes having wedge shaped portions may also be DC guard electrodes. By offsetting the ions between injecting the ions to the ion guide and ejecting the ions from the ion guide, it is possible to separate ions from neutral contaminants because the neutral molecules are not directed along the z axis and therefore will not be ejected from the ion guide via the exit.

FIG. 2B shows a side view of the ion guide 200, wherein one or more DC electrodes is a plate electrode, and the one or more electrodes are suspended between two RF surfaces by insulating spacers. One DC electrode is shown in FIG. 2B, however it will be appreciated that there may be a plurality of DC electrodes which are not visible in a side view, as each of the plurality of DC electrodes are in the same z-x plane. As shown in FIG. 2B the one or more DC electrodes 202 are mechanically connected to each of the RF surfaces 216a and 216b by use of a nut 210, a screw 212 which fix the two RF surfaces and one or more DC electrodes, i.e. the stack of surfaces, together. The stack of surfaces may comprise two sets of nuts, and bolts, such that the nuts and bolts are separated along the electrode. The one or more DC electrodes are spaced, i.e. separated, from each of the RF surfaces by two or more sets of spacers 214, wherein the spacers may be insulating spacers. There may be two spacers in each set which are attached to either surface of the DC electrode and subsequently attached to either of the RF surfaces. Alternatively, the one or more DC electrodes may have a hole, i.e. aperture, extending through the depth of the one or more DC electrodes, such that the spacer may be continuous and may pass through the one or more DC electrodes. Such a hole is shown in FIG. 2A wherein the hole, i.e. spacer point, 214 is shown. Therefore, there may be only one spacer in each set. The two sets of spacers are separated along the electrode, such that the spacers are in line with the set of nuts and bolts. The sets of nuts, bolts and spacers being spaced along the electrode results in the one or more DC electrodes being spaced from the RF surfaces by the same distance along the entirety of the one or more DC electrodes.

FIG. 2C shows another example of suspended DC electrodes, in which the DC electrode is suspended (i.e. attached or mounted to the ion guide) by plastic mounting at the sides of the device. As shown in FIG. 2C, the first and second RF surfaces 216a and 216b, and the one or more DC electrodes 202 are mounted to a mounting part 222. The mounting part may be located at the edge of the ion guide 200. The mounting part 222 is formed of an insulating material, for example the mounting part may be plastic. Alternatively, the mounting part may be composed of any material which is suitable for mounting the RF surfaces and DC plate electrode to the ion guide 200.

The plurality of DC electrodes 202 are shown, in FIG. 2A, 2B and 2C to be suspended, such that the DC electrodes form a layer which is in a plane different to the planes in which the RF surfaces are located. In other words, the one or more DC electrodes may be located in between the first and second surfaces, as described herein. The suspended DC electrodes, i.e. the DC electrode layer, may be located in a plane substantially parallel to the plane formed by the RF electrodes. However, it will be appreciated that the DC electrodes of any of the embodiments discussed herein may instead be located in the same plane as the one or more RF electrodes, i.e. located in the same plane as the RF surface. The DC electrodes may be printed on the same surface, i.e. same substrate, as the RF electrodes, such that the DC electrodes are formed from the same surface as the plurality of RF electrodes. Alternatively, the DC electrodes may be solid electrodes mounted to the same plane as the RF electrodes, or may be mounted beyond the plane of the RF electrodes.

The shape of the electrodes described herein provides the advantage that they may be constructed from low-cost material such as laser cut material, or they may be stamped or etched.

FIG. 3 shows an ion guide 300 which is configured to be used in a beam switching device. As described herein the ion guide comprises a first RF surface, and a second surface, wherein the second surface may be a second RF surface or a DC repeller plate. However, for clarity, the second RF surface is not illustrated in FIG. 3. As described in relation to FIGS. 2A, 2B and 2C, the ion guide comprises an entrance (i.e. inlet) and an exit (i.e. outlet). In the embodiment shown in FIG. 3, the ion guide comprises multiple apertures 320a, 320b, 318a and 318b which are each located in a corner of the RF surface. Two apertures are located on a first side of the ion guide, and two apertures are located on a second side of the ion guide, where the first and second sides are opposing sides. The apertures are configured to either admit or extract ions. The ion guide may comprise one entrance and one exit aperture, or the ion guide may comprise two entrance and two exit apertures. It will be appreciated that any aperture may be configured to be an exit aperture or an entrance aperture, so that the ions may enter and leave any of the apertures depending on the direction of the DC gradient, travelling wave or gas force, and the orientation of the DC electrode. For examples sake, FIG. 3 will be described in relation to entrance apertures 318a and 318b and exit apertures 320a and 320b.

The ion guide 300 comprises a first RF surface which comprises a plurality of RF electrodes which extend in the z direction, i.e. along a second axis. The plurality of RF electrodes also have a width in the x direction, i.e. along a first axis. The ion guide also comprises two DC electrodes 302a and 302b which are orientated such that they have a surface which is oblique to the x and z axes, i.e. oblique to the first and second axes, where in this example the DC electrodes have a wedge-shape. The wedge-shaped DC electrodes are located at the periphery of the device and the wedge DC electrodes extend in the z direction, such that both of the wide end and the narrow end are facing the z direction. The DC electrodes 302a and 302b are located on opposing sides of the ion guide, wherein these opposing sides are different sides to the sides on which the apertures are located. In other words, the apertures are located on a first and second side, and the DC electrodes are located on a third and fourth side of the RF surface. The apertures are located such that ions being admitted via any one of the apertures are initially travelling along the second axis, whereas the DC electrodes are located such that ions travelling along the first axis will reach the DC electrodes.

As described herein, the ions are directed along a first axis, and therefore ions which are admitted via any of the apertures of FIG. 3, are forced in a direction along the first axis after they have entered the ion guide. The oblique surface of the DC electrodes is oblique to the x axis, and ions travelling in the x direction due to the first force will interact with the oblique surface of the electrodes 302a and 302b. As shown in FIG. 3, in the embodiment in which the ion guide comprises two DC electrodes, the oblique surfaces of the two electrodes are slanted in opposite ways. In other words, in the example in which the DC electrodes are wedge shaped, the first electrode has a width in the x direction which decreases with an increase in z direction, whereas the second electrode has a width in the x direction which increases with an increase in z direction. Therefore, one DC electrode has a wide end at the side of the RF surface adjacent to the entrance aperture, and the other DC electrode has a thin end at the side of the RF surface adjacent to the entrance aperture. Therefore, the distance between the ion path and one DC electrode decreases with distance along the z axis, i.e. towards the exit aperture, whereas the distance between the ion path and the other DC electrode increases with distance along the z axis.

The ion guide 300 also comprises two DC guard electrodes 324a and 324b which are each overlapped by one of the DC electrodes 302a and 302b. In other words, the DC guard electrodes 324a and 324b are located adjacent to the first RF surface 316, and the DC electrodes 302a and 302b are located adjacent to the DC guard electrodes. In other words, the DC guard electrodes are located between the one or more DC electrodes and the first RF surface. However, it will be appreciated that the DC guard electrodes may instead be located between the one or more DC electrodes and the second surface, e.g. the second RF surface.

As described above, the two DC electrodes are located at opposing sides of the RF surface, wherein the opposing sides are different sides to the sides on which the apertures are located. The DC guard electrodes are therefore located at opposing sides, wherein the sides are the same sides at which the DC electrodes are located. The DC guard electrodes are located in a plane parallel to the plane in which the wedge-shaped DC electrodes are located. Therefore, the DC guard electrodes are each substantially aligned with one of the plurality of DC electrodes. As shown in FIG. 3, the DC guard electrodes are rectangular shaped, however the DC guard electrodes can be any suitable shape.

In one use of the ion guide of FIG. 300, the ions are admitted through the entrance 318a. The ions are admitted in the z direction, via the entrance 318a. A first force is applied to the ions in a first direction, wherein the force is applied by either a DC travelling wave, a DC gradient or a gas force. The first force is in an x direction, and therefore the admitted ions are forced in the x direction. In other words, the initial force on the ions is in the x direction. The ions are forced in the x direction, however the ions may already have inertia, and therefore the ions may not move solely in the x direction. In other words, the ions are forced in a first direction, however the ions may move in a direction different to the first direction. Instead, the ions may move along a path which has components in both the x direction and z direction. In other words, the path may not be a straight line, and instead may be a curved path or an angled path as described in other embodiments herein. In the embodiment shown in FIG. 3, the ions travel in an arc wherein the ions initially travel in a z direction and are subsequently forced by the first force in the x direction.

The ions travel towards the oblique surface of the DC electrode 302b, due to the first force, where the DC electrode is located on the opposing side of the RF surface to the entrance through which the ions are admitted. In other words, in this example the entrance is located at the back of the device, and the DC electrode is located at the front of the device. A DC is applied to the electrode 302b, wherein the DC is repulsive to the ions relative to the RF surface offset, but may be positive or negative relative to the DC guard electrode it overlaps. Therefore, in use, the potential generated by the guard electrode is perturbed and creates a DC gradient along the z axis. Therefore, the ions are directed in a direction along the z axis, towards an exit aperture. In other words, a second force is generated where the second force is orthogonal, i.e. perpendicular, to the first force. In other words, the second force has a component in a second axis, wherein the second axis is orthogonal to the first axis and the first axis is the direction in which the ions are initially forced. Therefore, as shown in FIG. 3, the ions are forced along the x axis and then are forced along the z axis, thus the ions follow a curved path to the exit aperture 320b.

The ion guide 300 therefore results in the ions being admitted in an entrance 318a and being ejected from an exit 320b wherein the exit is offset from the entrance in x direction. It will be appreciated that the ions may be admitted to any of the other apertures, and the same technical considerations would apply to provide a force to result in the ions leaving the ion guide through an aperture. The second force may be directed either in a positive z direction, or a negative z direction due to the orientation of the oblique surface described herein, i.e. the force may either be to the left or the right of the FIG. 3, such that the ions can be directed by the force to exit an aperture on the opposite side of the RF surface, as shown by the arrows in FIG. 3. For example, ions admitted into the bottom right aperture may exit the RF surface via the top left aperture, and ions admitted into the top right aperture may exit the RF surface via the bottom left aperture.

This system provides an advantage as the DC electrode alone can only push ions one-way, as setting it to the opposite polarity of the ions will pull them into the electrode. Therefore, the use of a DC guard electrode addresses this issue. Instead of having one or more DC guard electrodes, the repulsion may instead be provided by offsetting one or more of the last RF electrodes in the RF surface with a positive potential, providing a more mechanically simple configuration.

As shown in FIG. 3, the wedge-shaped DC electrode, and its oblique surface, extends along the width of the RF surface, in the z direction, such that the wedge-shaped DC electrode covers the entire width of the device, or nearly the entire width of the device. The size and the applied voltage of the wedge-shaped DC electrode may be dependent on the positioning of the DC guard electrodes. For example, the DC guard electrode may have a voltage of +10V, and therefore the wedge-shaped DC electrode may have a voltage of 0 to 20V to generate DC gradients in either direction. Part or all of a wedge-shaped DC electrode may overhang the DC guard electrodes, or be recessed. However, it is beneficial for the wedge-shaped DC electrode and DC guard electrodes to neither overhang excessively nor be recessed excessively relative to the DC electrodes, to enable balance between the two potential sources.

FIG. 4 shows another example of an ion guide 400. The ion guide 400 comprises the same features as ion guide 300. However, instead of comprising two DC guard electrodes as described above, the ion guide 400 comprises a second pair of wedge-shaped DC electrodes 402c and 402d. Therefore, the ion guide 400 will be described as comprising an upper electrode pair (e.g. an upper wedge DC electrode pair) 402b and 402a, and a lower electrode pair 402d and 402c (e.g. upper wedge electrode pair). As described herein, the DC electrodes in this example are wedge shaped, however any suitably shaped electrode (e.g. having a surface oblique to a first and second axis) may be used in this example. The upper wedge electrode pair is located in a plane parallel to the plane in which the lower wedge electrode pair is located. The upper wedge electrode pair is located substantially in line with the lower wedge electrode pair, such that each of the electrodes of the upper wedge electrode pair overlays each of the electrodes of the lower wedge electrode pair. In other words, the upper wedge electrodes are located in the same position as the lower wedge electrodes relative to the x and z axes. However, as shown in FIG. 4, the electrodes of the lower wedge electrode pair are orientated such that the wide end of the lower wedge electrode is at an opposite side of the RF surface, in the z axis, to the wide end of the upper wedge electrodes.

As described in relation to FIG. 3, one electrode of the upper wedge electrode pair has a width which decreases with distance along the z axis, whereas the other electrode of the upper wedge electrode pair has a width which increases with distance along the z axis. The same applies for the lower electrode pair, where the electrode width decreases or increases in the opposite direction to the upper electrode pair, as shown in FIG. 3. Therefore, the oblique surfaces of the upper electrode pair are slanted in the opposite direction to the oblique surface of the lower electrode pair. The additional pair of electrodes provides a potential gradient in an alternative way to the guard DC electrodes of the ion guide 300. A stronger repulsive potential may be applied to one of the additional electrodes to generate a potential gradient in one of the directions.

A buffer gas may be applied to the device described in FIGS. 3 and 4, for example a buffer gas greater than or equal to 1×10⁻³ mbar may be applied to cool the ions. Cooling the ions has the advantage that the ions have a reduced kinetic energy and therefore remain in the ion guide after being admitted, and their motion can be controlled by the various electric fields created by the ion guide. Furthermore, ions with a reduced kinetic energy are easier to focus, therefore providing better transmission and reducing unwanted fragmentation when used in an ion guide, as described herein.

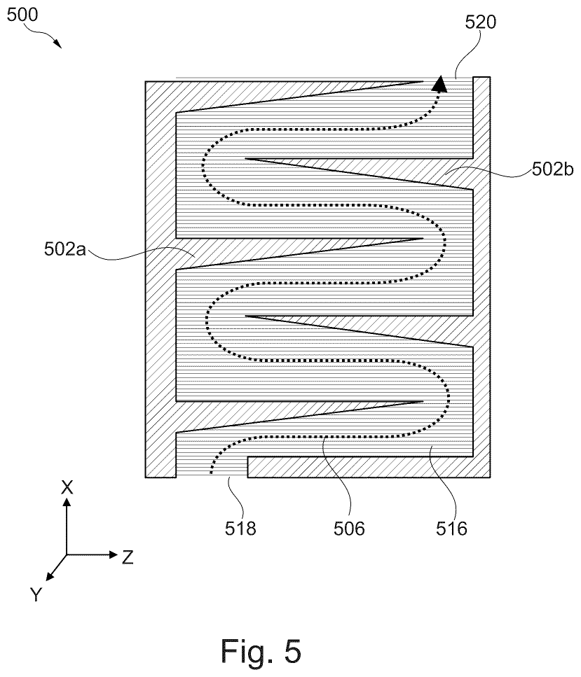

FIG. 5 shows an example of an ion guide according to an embodiment. The ion guide 500 provides an increased path length of ions, wherein the path length is increased by creating a winding path which the ions follow. In other words, the ion guide is used to generate an elongated ion path. The ion guide may be used for ion mobility separation. The ion guide comprises a first RF surface 516 and a second surface (not shown) as described herein. The ion guide also comprises an entrance 518 and an exit 520 located on opposing sides of the ion guide, such that the entrance and exit are located at the front and the back of the device, i.e. at the front and back of the RF surface. The ion guide comprises a number of wedge-shaped DC electrodes where two wedge shaped DC electrodes have been labelled 502a, 502b. A number of wedge-shaped DC electrodes are located on a first side of the RF surface 516 and a number of wedge-shaped DC electrodes are located on a second side of the RF surface 516. The wedge-shaped DC electrodes extend from different sides to sides on which the entrance and exit are located. In other words, the entrance and exit may be considered as being on a first and second side of the RF surface, and the wedge-shaped DC electrodes are considered as extending from a third and fourth side of the RF surface. Each of the wedge-shaped DC electrodes are orientated such that their wide ends are located at the periphery of the RF surface, and their thin ends are positioned over the RF surface. Therefore, wedge shaped DC electrodes located on one surface have a width which decreases with distance in the z direction, whereas wedge shaped DC electrodes on the opposing surface have a width which increases with distance in the z direction.

The wedge-shaped DC electrodes are offset from each other such that the wedge-shaped DC electrodes located on a first side of the RF surface are located at different positions along the x axis compared to the location of the wedge shaped DC electrodes on the second side of the RF surface. Therefore, the line of sight from the entrance 518 to the exit 520 is broken, i.e. blocked, by the plurality of wedge-shaped DC electrodes, such that it is not possible for the ions to travel in a straight line from the entrance to the exit. Therefore, the ion path 506 must bend for the admitted ions to reach the exit. Therefore, a long DC channel is created. Each of the plurality of wedge-shaped DC electrodes has an oblique surface which interacts with the ions travelling along the ion path. Therefore, the oblique surface of each of the plurality of wedge-shaped DC electrodes faces the entrance aperture 518.

The ions are admitted into the ion guide in an x direction. The ions are moved along an x direction by a DC gradient or travelling wave being applied to the array of RF electrodes, or by a gas force being applied to the ions. Therefore, an initial force is applied to the ions which directs them in the x direction. In the example in which the ions are moved in the x direction by a travelling wave, the travelling wave is superimposed on the RF electrodes, running with 4+ phases of additional superimposed RF, with each phase 90 degrees out and running at a lower voltage and frequency than the trapping waveform. For example, the traveling wave may be 5 to 50V, with a frequency of 50 to 250KHz. Travelling waves may also be implemented as a series of applying transient DC pulses, giving the impression of a DC pulse moving down the electrode series, often 1 or 2 electrodes up and 3-6 electrodes down at a time.

A second force is applied to the ions by each of the wedge-shaped DC electrodes, wherein the second force is orthogonal to the first force. Therefore, ions which are initially directed in the x direction are directed in the z direction by the second force. As the wedge-shaped DC electrodes all have a width which decreases from the edge of the RF surface towards the centre of the RF surface, the force created from electrodes extending from one side of the RF surface is in the direction opposite to the force created from electrodes extending from the opposing side. Therefore, the ions feel a force in the positive z direction due to one wedge shaped DC electrode 502a, and the ions subsequently feel a force in the negative z direction due to the opposite wedge-shaped DC electrode 502b. Therefore, the ions follow a winding path in which the ions move in positive and negative directions. However, the ions are constantly moving in a positive direction relative to the x axis, i.e. the ions are always moving from the entrance to the exit aperture. In this way, the length of the ion path is increased without requiring a longer ion guide. It will be appreciated that although FIG. 5 shows the ion guide as comprising five wedge shaped DC electrodes, the number of electrodes could be greater or fewer than shown, to increase or decrease the length of the ion path 506.

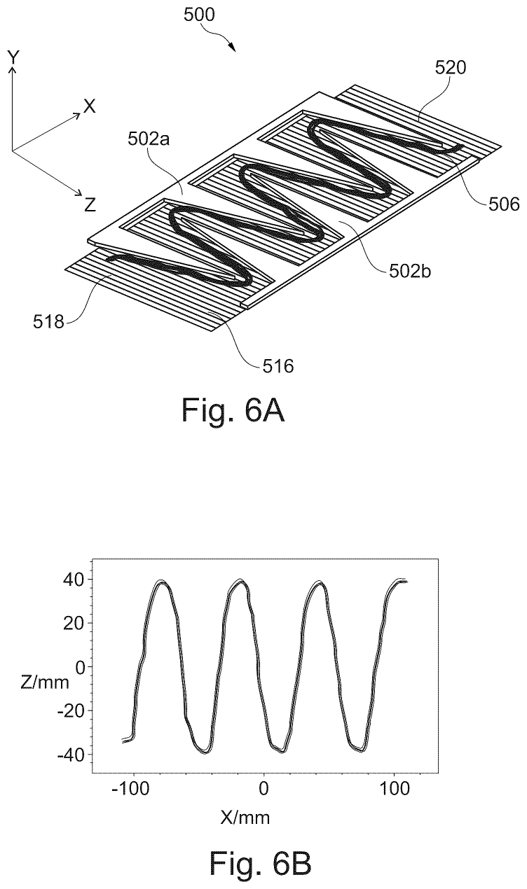

FIG. 6A shows an ion trajectory simulation of the device 500 of FIG. 5. FIG. 6B shows the ion path of ions injected into the ion guide 500. The features of the device in FIG. 5 are the same as the features of the device described in relation to FIG. 5. Therefore, the features are labelled the same as in FIG. 5, and will not be described in detail herein. Instead, the reader is directed to the description of features in relation to FIG. 5. In the simulated device shown in FIG. 6A, the device has the dimensions X=200, Y=10 mm, Z=100 mm, wherein X is the width, Y is the depth, and Z is the length. The model shown in FIG. 6A is composed of two opposing stacks of 4 mm wide RF electrodes, wherein the opposing stacks are 10 mm apart, with each electrode in series carrying an opposite phase of the applied 2 MHz, 250Vₚₑₐₖ₋ₚₑₐₖ RF applied. A 1V/mm DC gradient was superimposed to drive ions along the x direction. A series of seven 20 mm wide, 80 mm long wedge electrodes with +10V applied were arranged as described in relation to FIG. 5. A buffer gas had a pressure set to 1×10⁻² mbar. However, it will be appreciated that the buffer gas could be increased, to greater than or equal to 1mbar for ion mobility applications.

In the simulation, m/z 200 ions were inserted into the ion guide 500. As shown in FIG. 6B, the ions follow a winding, i.e. zigzag, or meandering, path. In other words, the ion path has a curved shape in which the ions have a path which alternates between travelling in a positive and negative z direction.

An ion mobility separator may comprise an ion guide according to an embodiment described herein, such as the ion guide 500. It will be appreciated that such an ion mobility separator will be required to have an accumulating or trapping region at the front of the device, wherein the accumulating or trapping region may be any suitable known region, which is not described herein.

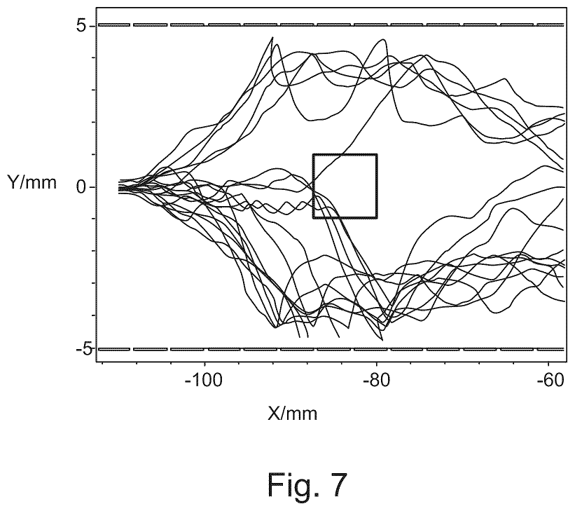

FIG. 7 shows the ion path of another simulation of the ion guide 500. In this simulation the wedge electrodes have a thickness of 2 mm, and a low repulsive potential of +10V, whereas the superimposed DC gradient was set high, for example equal to or greater than 100V. As shown in FIG. 7, the repulsion was not sufficient to block the flow of ions, but effectively split the RF channel into 2 channels as ions flow around the wedge electrode. This is shown in FIG. 7, where the ion beam is effectively split into two and then remerges.

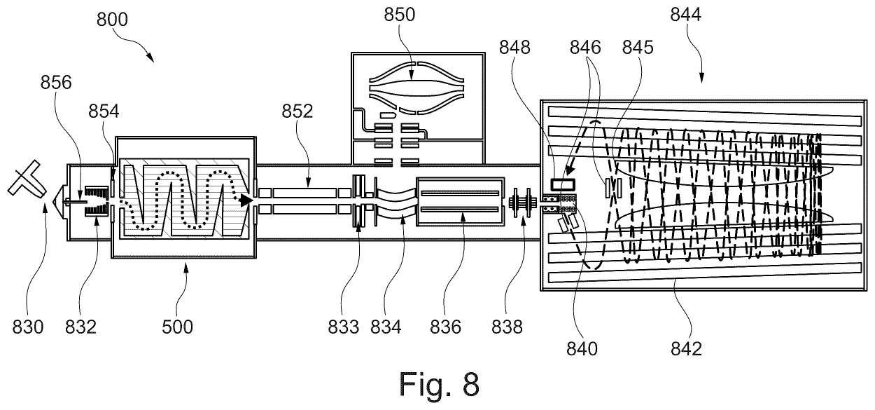

FIG. 8 shows a mass spectrometer 800 incorporating an ion guide according to an embodiment described herein. The mass spectrometer of FIG. 8 incorporates ion guide 500, in which an elongated path is formed by a series of wedged electrodes. The mass spectrometer may comprise some or all of the features of the mass spectrometer 10 described in U.S. Pat. No. 10,699,888B2, which is hereby incorporated by reference in its entirety. The mass spectrometer of the present disclosure comprises an ion mobility separator which incorporates an ion guide of the present disclosure, such as ion guide 500, wherein the winding path of the ion guide separates ions by mobility, mass to charge ratio (m/z) and charge state. As is described herein, the ions follow a winding path due to electrodes having one or more oblique surfaces which cause ions travelling through the ion guide to be directed by a number of forces. The ion guide adds both ion mobility information to the mass analysis, and works in a conjoined fashion with the quadrupole to limit the proportion of ions becoming deposited on the rods of the quadrupole.

It will be noted that the mass spectrometer of described herein, and shown in FIG. 8 of the present disclosure, has the same technical effects and considerations as the mass spectrometer 10 described in U.S. Pat. No. 10,699,888B2. The difference between the mass spectrometer of the present application and U.S. Pat. No. 10,699,888B2 is that the present mass spectrometer 800 comprises an ion mobility separator according to an embodiment of the present disclosure. This feature will be described herein in relation to the mass spectrometer, however for a complete description of the remaining features shown in FIG. 8, the reader is referred to U.S. Pat. No. 10,699,888B2 whose corresponding features have the same effect and purpose as the features shown in FIG. 8.

Ions are generated from a sample by an electrospray ion source 830 and are directed by a capillary 856 into an RF-only S lens 832, also known as an ion funnel. In this case the ion funnel acts an accumulating device for pulsed introduction to the ion mobility separator 500, where the ion mobility separator comprises an ion guide according to an embodiment of the present disclosure. Alternatively, instead of an ion funnel, such functionality may be incorporated into the ion mobility separator itself with use of a gate electrode. Ions pass into the ion mobility separator 500 via a calibrant source 854 and travel through the ion guide, becoming separated by mobility, and substantially by mass to charge ratios (m/z) and charge state. The ions pass from the ion mobility separator 500 to a mass selector, in the form of a quadrupole mass filter 852. The quadrupole mass filter 852 is typically but not necessarily segmented and serves as a band pass filter, allowing passage of a selected mass number or limited mass range whilst excluding ions of other mass to charge ratios (m/z). The mass filter can also be operated in an RF-only mode in which it is not mass selective, i.e. it transmits substantially all m/z ions. For example, the quadrupole mass filter 852 may be controlled by a controller to select a range of mass to charge ratios which are allowed to pass, whilst the other ions in the precursor ion stream are filtered (attenuated). Although a quadrupole mass filter is shown in FIG. 8, the skilled person will appreciate that other types of mass selection devices may also be suitable for selecting precursor ions within the mass range of interest. For example, an ion separator as described in US-A-2015287585, an ion trap as described in WO-A-2013076307, an ion mobility separator as described in US-A-2012256083, an ion gate mass selection device as described in WO-A-2012175517, or a charged particle trap as described in U.S. Pat. No. 799,223, the contents of which are hereby incorporated by reference in their entirety. The skilled person will appreciate that other methods selecting precursor ions according to ion mobility, differential mobility and/or transverse modulation may also be suitable.

The isolation of a plurality of ions of different masses or mass ranges may also be performed using the method known as synchronous precursor scanning (SPS) in an ion trap. Furthermore, in some embodiments, more than one ion selection or mass selection device may be provided. For example, a further mass selection device may be provided downstream of the fragmentation chamber 836. In this way, MS³ or MSⁿ scans can be performed if desired (typically using the ToF mass analyser for mass analysis).

The mass filtered ions are guided from the quadrupole mass filter 852 into a curved linear ion trap (C-trap) 834, via a charge detector 833. Cooled ions reside in a cloud towards the bottom of the potential well and are then ejected orthogonally from the C-trap towards the second mass analyser 850. As shown in FIG. 8, the second mass analyser is a Fourier transform mass analyser, such as an orbital trapping mass analyser 850, for example the Orbitrap™ mass analyser sold by Thermo Fisher Scientific, Inc. The Fourier transform mass analyser 850 has an off-centre injection aperture and the ions are injected into the orbital trapping mass analyser 850 as coherent packets, through the off-centre injection aperture. Ions are then trapped within the orbital trapping mass analyser by a hyperlogarithmic electric field, and undergo back and forth motion in a longitudinal direction whilst orbiting around the inner electrode.

The axial (z) component of the movement of the ion packets in the orbital trapping mass analyser is (more or less) defined as simple harmonic motion, with the angular frequency in the z direction being related to the square root of the mass to charge ratio of a given ion species. Thus, over time, ions separate in accordance with their mass to charge ratio.

In the configuration described above, the sample ions (more specifically, a mass range segment of the sample ions within a mass range of interest, selected by the quadrupole mass filter 852) are analysed by the orbital trapping mass analyser 850 without fragmentation. The resulting mass spectrum is denoted MS1.

Although an orbital trapping mass analyser 850 is shown in FIG. 8, other mass analysers including other Fourier Transform mass analysers may be employed instead. For example, a Fourier Transform Ion Cyclotron Resonance (FTICR) mass analyser may be utilised as mass analyser for the MS1 scans. Mass analysers, such as the orbital trapping mass analyser and Ion Cyclotron Resonance mass analyser, may also be used in embodiments even where other types of signal processing than Fourier transformation are used to obtain mass spectral information from the transient signal (see for example WO 2013/171313, Thermo Fisher Scientific).

Ions in the orbital trapping mass analyser are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In a second mode of operation of the C-trap, ions passing through the quadrupole mass filter into the C-trap may also continue their path through the C-trap and fragmentation chamber 836, which may be an “Ion Routing Multipole” (IRM) collision cell. As such, the C-trap effectively operates as an ion guide in the second mode of operation. Alternatively, cooled ions in the C-trap 834 may be ejected from the C-trap in an axial direction into the fragmentation chamber 836. The fragmentation chamber 836 is, in the mass spectrometer 800 of FIG. 8, a high energy collisional dissociation (HCD) device to which a collision gas is supplied. Precursor ions arriving into the fragmentation chamber collide with collision gas molecules resulting in fragmentation of the precursor ions into fragment ions.

Although an HCD fragmentation chamber 836 is shown in FIG. 8, other fragmentation devices may be employed instead, employing such methods as collision induced dissociation (CID), electron capture dissociation (ECD), electron transfer dissociation (ETD), photodissociation, and so forth. Moreover, ion fragmentation may be performed in a high-pressure region of the extraction trap 14.

Fragmented ions may be ejected from the fragmentation chamber 836 at the opposing axial end to the C-trap 834. The ejected fragmented ions pass into a second transfer multipole 838, i.e. a multipole ion guide. The second transfer multipole 838 guides the fragmented ions from the fragmentation chamber 836 into an extraction trap (second ion trap) 848. The extraction trap 848 is a radio frequency voltage-controlled trap containing a buffer gas. For example, a suitable buffer gas is argon at a pressure in the range 5×10⁻⁴ mBar to 1×10⁻² mBar. The extraction trap has the ability to quickly switch off the applied RF voltage and apply a DC voltage to extract the trapped ions. A suitable flat plate extraction trap, also referred to as a rectilinear ion trap, is further described in U.S. Pat. No. 9,548,195, which is herein incorporated by reference. Alternatively, a C-trap may also be suitable for use as a second ion trap.

The extraction trap 838 is provided to form an ion packet of fragmented ions, prior to injection into the time-of-flight mass analyser 844. The extraction trap accumulates fragmented ions prior to injection of the fragmented ions into the time-of-flight mass analyser 844, wherein the time-of-flight mass analyser 844 may be the multiple reflection time-of-flight mass analyser (MR-ToF) described in U.S. Pat. No. 10,699,888B2. As described in U.S. Pat. No. 10,699,888B2, the MR-ToF comprises a detector 848, deflectors 846, correcting stripe electrode 845, extraction trap 840, and tilted ion mirrors 842. MS1 and MS2 scans may be performed by the MR-ToF 844 or the orbital trapping mass analyser 850.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

The examples here show surfaces with a 1D array of elongated RF electrodes. It is also possible to separate electrodes into a 2D array, so that each RF electrode is surrounded by electrodes of the opposite polarity.

The methods and apparatus of the present disclosure can be utilised with a variety of electrode structures. Electrodes of appropriate dimensions can be arranged into symmetrical or asymmetrical patterns upon substrates and if elongation of electrodes is beneficial for a particular application, the electrodes may be linear or curving. Individual electrodes can be planar, hemispherical, rectangular or of other shapes. The electrodes may be PCB printed electrodes.

Whilst the ion guiding system 200, 300, 400, 500 is described as having a height (or depth) in a y-direction, a length in a z-direction and a width in an x-direction, it will be appreciated that the x-, y- and z-axes may be defined in other manners. For example, an ion guiding system that is rotated with respect to the ion guiding system 200, 300, 400, 500 shown in the drawings may be provided, without departing from the disclosure.

Furthermore, it will be appreciated that the x-, y- and z-axes are exemplary. For instance, the “height” of the ion guiding system may be along the x- or z-axis defined in the drawings. Likewise, the “width” of the ion guiding system (defined in the x direction herein) may be defined along the z- or y-axis and the “length” of the ion guiding system (distance between the multipole electrodes and RF surface electrodes) may be defined along the x- or y-axis.

Although FIGS. 2A, 3, 4, 5, 6A illustrate the plurality of electrodes extending in the z-direction, it will be appreciated that the electrodes could extend in other directions (for example, to change the direction of the guiding force applied by the RF electrodes.

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (for example, 10%, 20% or 50%) or less than 5% (for example, 2% or 1%).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element may instead be termed a “second” element) and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

Unless otherwise described, all technical and scientific terms used herein have a meaning as is commonly understood by one of ordinary skill in the art to which the various embodiments described herein belongs.

1. An ion guide comprising:
an entrance for admission of ions into the ion guide, wherein the admitted ions are directed along a first axis;
a confinement device comprising an array of radio frequency (RF) electrodes formed along a first surface and configured to provide an RF field for confinement of the admitted ions; and
a first direct current (DC) electrode configured to receive a DC potential and thereby provide a force on the admitted ions having a component in a second axis that is perpendicular to the first axis, the first DC electrode having a surface that is oblique to the first and second axes.

2. An ion guide according to claim 1, wherein the first DC electrode has a triangular cross section.

3. An ion guide according to claim 1, wherein the first DC electrode extends in the same plane as the array of RF electrodes.

4. An ion guide according to claim 1, wherein a second RF surface or counter-electrode is located at a second surface of the confinement device, wherein the second surface is arranged opposite the first surface.

5. An ion guide according to claim 4, wherein the first DC electrode is located between the first and second surfaces.

6. An ion guide according to claim 4, wherein the first DC electrode is configured such that it is not in direct contact with either of the first surface or the second surface.

7. An ion guide according to claim 1, wherein the first DC electrode is one of a plurality of DC electrodes, wherein each of the plurality of DC electrodes extends in the same plane.

8. An ion guide according to claim 4, wherein the first DC electrode is located at a periphery of the first surface and/or the second surface.

9. An ion guide according to claim 1, further comprising one or more DC guard electrodes located between the first and second surfaces or in the same plane as the first or second surface, wherein the one or more DC guard electrodes are configured to provide an additional force on the admitted ions.

10. An ion guide according to claim 1, further comprising a first DC guard electrode, wherein the first DC guard electrode and the first DC electrode are configured such that the force provided on the admitted ions can be controlled to be either in a first direction along the first axis or in a second direction along the first axis.

11. An ion guide according to claim 10, further comprising a second DC electrode and a second DC guard electrode, wherein the first DC electrode is located on a different side of an ion path to the second DC electrode, and wherein the first DC guard electrode is located on a different side of an ion path to the second DC guard electrode.

12. An ion guide according to claim 11, wherein the first DC electrode is an upper DC electrode, and the ion guide further comprises a lower DC electrode, and wherein the upper DC electrode and the lower DC electrode are configured such that the force provided on the admitted ions can be controlled to be either in a first direction along the first axis or in a second direction along the first axis.

13. An ion guide according to claim 12, wherein the upper DC electrode is one of a pair of upper DC electrodes, and the lower DC electrode is one of a pair of lower DC electrodes, wherein one electrode of the pair of upper DC electrodes is located on a different side of the ion path to the other electrode of the pair of upper DC electrodes, and wherein one electrode of the pair of lower DC electrodes is located on a different side of the ion path to the electrode of the pair of lower DC electrodes.

14. An ion guide according claim 1, wherein the ion guide further comprises an exit through which ions are extracted.

15. An ion guide according to claim 14 wherein the entrance and the exit are located in the same plane that is substantially parallel to the first surface.

16. An ion guide according to claim 14, wherein the exit is offset from the entrance along the second axis.

17. An ion guide according to claim 14, wherein the ion guide comprises a second DC electrode, wherein the exit is located between the first and second DC electrodes, and wherein the first and second DC electrodes are configured such that the ions are compressed along a z-axis when they are extracted through the exit.

18. An ion guide according to claim 14, wherein the first DC electrode is one of a plurality of DC electrodes, wherein each of the plurality of electrodes is separated, along the first axis, from the other electrodes in the plurality of electrodes, and wherein each of the plurality of electrodes has a surface which is oblique to the first and second axes, and wherein one or more of the plurality of electrodes are arranged such that the ions are forced in a first direction along the first axis, and wherein one or more of the plurality of electrodes are arranged such that the ions are forced in a second direction along the first axis, such that the ion guide is configured to cause the ions to follow a curved and/or angled path between the entrance and the exit.

19. An ion guide according to claim 14, wherein the ion guide is configured to cause the ions to follow a winding ion path between the entrance and the exit.

20. An ion guide according claim 1, wherein the entrance is configured such that ions are admitted into the ion guide along the first axis, or wherein the entrance is configured such that ions are admitted into the ion guide in a direction different to the first axis.

21. An ion guide according claim 1, wherein the array of RF electrodes forms an RF surface.

22. A beam switching device comprising the ion guide of claim 1.

23. An ion mobility separator comprising the ion guide of claim 1.

24. An analytical instrument comprising the ion guide of claim 1.

25. The analytical instrument of claim 24, wherein the analytical instrument is a mass spectrometer or an ion mobility spectrometer.
